(19) United States
(12) Patent Application Publication
(10) Pub. No.: US 2023/0124356 A1
(43) Pub. Date: Apr. 20, 2023

(54) COVERAGE-PATH PLANNING METHOD FOR SINGLE UNMANNED SURFACE MAPPING VESSEL

(71) Applicant: WUHAN UNIVERSITY OF TECHNOLOGY, WUHAN (CN)

(72) Inventors: Yong MA, WUHAN (CN); Jing WANG, WUHAN (CN); Huaxiong BI, WUHAN (CN); Xinping YAN, WUHAN (CN); Yuanzhou ZHENG, WUHAN (CN)

(73) Assignee: WUHAN UNIVERSITY OF TECHNOLOGY, WUHAN (CN)

(21) Appl. No.: 18/069,986

(22) Filed: Dec. 21, 2022

Related U.S. Application Data
(63) Continuation of application No. PCT/CN2021/117160, filed on Sep. 8, 2021.

(30) Foreign Application Priority Data
Sep. 18, 2020 (CN) 202010987645.4

(51) Int. Cl. G05D 1/02; G08G 3/02

(52) U.S. Cl. CPC G05D 1/0206; G08G 3/02

(57) ABSTRACT

An optimized coverage-path planning method for a single unmanned surface mapping vessel (USMV), includes: initializing GT values of all grids as ue, pre-configuring each grid assigned value BVₐ₀, inputting coordinates, continuing to update a pre-configured map; importing a static map according to the grids; inputting coordinates and continuing to update the pre-configured map according to the static map; outputting, by a USMV, position information ω and obstacle information η thereof according to the pre-configured map, and starting to update the map; outputting a grid status list GT_list according to the updated map, and receiving, by a BL₀-level map, input map information and USMV information, starting path planning, and outputting a target point tp to the USMV; if the solution is trapped in a local optimum at the BL₀ level, updating each map level in ascending order, and searching the corresponding level for the tp.

### CROSS-REFERENCE TO RELATED APPLICATIONS

This application is a continuation of International Patent Application No. PCT/CN2021/117160 with a filing date of Sep. 8, 2021, designating the United States, now pending, and further claims priority to Chinese Patent Application No. 202010987645.4 with a filing date of Sep. 8, 2020. The content of the aforementioned applications, including any intervening amendments thereto, are incorporated herein by reference.

### TECHNICAL FIELD

The present invention belongs to the field of path planning, and more particularly, relates to a coverage-path planning method (IBA*) for a single unmanned surface mapping vessel.

### BACKGROUND

Marine surveying is the basic work for building marine informationization, which has important economic significance for the development of national marine resources. Surveyors are faced with the problems of high labor intensity and high safety risks. All kinds of dangerous scenes make it difficult to implement traditional measurement methods.

The Unmanned Surface Vessel (USV) is a kind of marine intelligent platform which can navigate autonomously and safely in various marine environments and perform various tasks. The Unmanned Surface Mapping Vessel (USMV) used in ocean surveying can improve the efficiency of surveying and mapping operations, reduce the cost of mapping underwater topography and operational safety risks, and is very suitable for replacing or assisting traditional ocean surveying, thus having broad application prospects. At present, a single USMV is vulnerable to the limitations of endurance and operation efficiency in measuring coverage operation, while multi-USMV collaborative scanning can improve the efficiency of area coverage operation and shorten the time to complete tasks, so it has better task execution ability. As the basis and premise of collaborative surveying on water, it is of great significance to carry out research on multi-USV coverage path planning.

At present, the research on coverage path planning mostly focuses on the field of ground mobile robots. Compared with the ground mobile robot, the working range of the USMV is wider and the water environment is more complex, which requires higher efficiency and robustness of the coverage path planning algorithm.

### SUMMARY

Against the above deficiencies or improved needs of the prior art, the present invention proposes a coverage-path planning method for a single unmanned surface mapping vessel to improve the coverage rate and coverage effect in a complex operating environment of the unmanned surface mapping vessel and improve the operational efficiency of the unmanned surface mapping vessel.

To achieve the above objectives, in accordance with one aspect of the present invention, there is provided a coverage-path planning method for a single unmanned surface mapping vessel, including:

(1) rasterizing an environmental map, initializing GT values of all grids as ue, assigning a value BVₐ₀ to a grid a₀ in a BL₀-level map, then importing an initialized environmental map, inputting coordinates, and continuing to update the environmental map, wherein the ue represents the free space where the bathymetry mission is not completed;

(2) outputting, by a USMV, position information ω and obstacle information η thereof according to the updated environmental map, starting to update an environmental map, outputting a grid status list GT_list according to the updated environmental map, and receiving, by the BL₀-level map, input map information and USMV information according to the GT_list, starting path planning, and outputting a target point tp to the USMV, wherein the tp represents an index value of the grid where a next target point of the USMV is located;

(3) if the solution is trapped in a local optimum at the BL₀-level map, updating each map level BL₀ in ascending order, and searching the corresponding level for the tp, if a tp list is acquired, calculating a final tp according to a cost value, transmitting the final tp to the USMV, and causing the USMV to switch to a tr state, and when the tr state is entered, entering the BL₀-level map and continuing to perform planning, wherein the tr state represents a non-normal task state after the USMV is in a Travel state and reaches local optimum; and

(4) if still no target point tp is found at the map corresponding to the highest level BL_{L}, ending the task, checking the status of the highest level BL_{L} map, and outputting an E state, wherein the E state represents an end state.

In some alternative embodiments, the step (1) includes:

updating the GT_list first, since the USMV has not yet started to traverse and the number of exps is 0, defining the vast majority of grids as a ue state, calculating a preset assigned value BVₐ₀ of the grid a₀ in the BL₀-level map and updating level by level till the highest BL_{L}-level, eventually importing environmental map information, updating obstacles, exclusion zones, and navigable waters, respectively, at the same time, starting, by the USMV, recording and transferring position information ω and obstacle information η thereof, thus starting circular traversal officially, wherein the exp represents the free space where the bathymetry mission has been completed.

In some alternative embodiments, the step (2) includes:

recording a detection field of the USMV in the updated environmental map as D⁰(ω), ω∈D⁰(ω), wherein the D⁰(ω) contains all the grid information perceptible to the USMV at the current position;

for each grid a₀ in the D⁰(ω), if a connection line with the ω does not pass through a grid in a fz or obs state and a potential energy value of the grid a₀ is positive, defining a grid set satisfying the above requirements as a priority field F⁰⊆D⁰(μ), wherein the D⁰(μ) represents the priority field determined from the D⁰(ω);

for coverage of the BL₀-level map, since a priority path of the USMV is to complete the coverage task in the direction of a single scanning line, preferentially selecting the grid on the same scanning line in the D⁰(ω) as the target point, defining the grids in the D⁰(ω) in both north and south directions as ω^{N} and ω^{s}, if BV_{ω}>0 and {ω^{N},ω^{S}}⊂F⁰, wherein, the BV is the grid potential value, in order to circumvent the case of massive backtracking, preferentially selecting the grid adjacent to the obstacle from the two grids, denoting the grid as tp_{obs}, in the case where both the ω^{N} and ω^{s} meet the condition, introducing both into a cost calculation formula to calculate the potential cost values J(tp) produced by both paths, and selecting a relatively optimum path from local and global points of view;

if there is an adjacent obstacle on only one side of ω^{N} and ω^{s}, then then giving priority to a ω^{N} or ω^{s} orientation where the adjacent obstacle is located to start traversal, wherein in the case of BV_{ω}>0, the ω grid where the USMV is located has not yet been explored, in the two upper and lower orientations, one side is the mission completion or obstacle area and the other side is the free space that has not yet been explored, at the moment, the ω is the tp point, and the USMV switches to a tc instruction which guides the USMV to start the actual bathymetry mission;

if BV_{ω}=0, F⁰≠Ø, determining that the USMV has completed the task on the single scanning line, starting to turn to the next phase of traversal, at the moment, taking the grid α₀ with the largest BV_{F}_{⁰}_{(ω)} as the tp point, starting the next action; and

if none of the above cases are met, determining that the USMV is in the locally optimum state at the moment, wherein the most likely case is driving into a concave obstacle field or being surrounded by an area with BV≤0, at the moment, starting the high-level map phase for path finding, and outputting a tr instruction.

In some alternative embodiments, the priority field is determined by:

F⁰={α₀∈D⁰(ω):BV_{α}_{₀}>0}.

In some alternative embodiments, the potential cost value is determined by:

J(tp)=k_{θ}·θ(ω,tp)+k_{d}·d(ω,tp)+kᵤₗ·Nₑₓₚ,

wherein,

d(ω,tp)=∥(ωₓ,ω_{y})−(tpₓ,tp_{y})∥₂,

k_{θ} represents a turn cost coefficient and is considered as a unit turn angle cost; θ represents an absolute value of an angular change; k_{d} represents a distance cost coefficient, and is considered as a unit distance movement cost; d represents a Euclidean distance; kᵤₗ represents a global trend coefficient and is considered as as the cost of changing the situation; Nₑₓₚ represents the number of ue-state grids in the input direction, (ωₓ,ω_{y}) represents the horizontal and vertical coordinates of the ω point, and (tpₓ,tp_{y}) represents the horizontal and vertical coordinates of the tp point.

In some alternative embodiments, the step (3) includes:

switching to a BLₗ-level phase with l=1, finding a level-1 map grid α₁ with the largest BV_{F}_{^{l}}_{(ω)} in F^{l}, wherein, according to the map update manner, a high-level grid contains its corresponding low-level grid, at the moment, there may be no less than 2 tp points in the high-level grid tp list; continuing to calculate its potential cost value J(tp) in the COM state, selecting the optimum tp point, making the USMV start the bathymetry task, and defining the detection field and priority field at the BLₗ-level map phase: defining the USMV detection field at the ω position in the BLₗ-level map and having the detection range of R_{L} as D^{l}(ω), wherein ω∈D^{l}(ω); defining the field in the detection domain D^{l}(ω) that is reachable through an adjacent path with ω and is positive in the BV_{α}_{ₗ} value as the priority field F^{l}⊆(ω); wherein the BLₗ-level map phase refers to a phase where the level is higher than the BL₀-level map, i.e. 1≤l≤L and L represents the number of map phases; and

since the local optimum case occurs in the vast majority of cases at the end of the obstacle or at the end of the scanning line, calculating an adjacent path in the tr state with a greedy algorithm, i.e. continuing to track the obstacle contour until moving directly to the target point, breaking away from the state of entering the locally optimum area and reaching the target point, in the scanning task, for a scenario in which a dynamic obstacle exists, performing a collision avoidance action by the USMV, and switching to the tr state, continuing to enter the BL₀-level map after past and clear, resuming the coverage operation, if it is still impossible to break away from the local optimum when l=1, updating the map level by level until the tp point is derived and if there is no solution when l=L, then preliminarily determining that the traversal is completed.

In some alternative embodiments, at the BLₗ-level map phase, the priority domain is specifically expressed as:

F^{l}={αₗ∈D^{l}(ω):BV_{α}_{ₗ}>0}.

In some alternative embodiments, the step (4) includes:

based on the known partial environmental information, reviewing missing areas, generating coverage rate information, and considering whether to switch the tr state to perform the return or continue the scanning task in a specific area according to the actual state requirements of the USMV.

According to another aspect of the present invention, there is provided a computer readable storage medium having stored thereon a computer program which, when executed by a processor, implements the steps of the method of any of the above.

In general, the above solutions conceived by the present invention can achieve the following advantageous effects compared to the prior art:

According to the invention, the traditional coverage path planning algorithm is used for reference, the research on cooperative coverage path planning of multiple USMVs is carried out in depth, and the IBA* (Improved BA*) algorithm is designed to plan a high-efficiency and high-quality scanning path for the USMV. Simulation results show that the performance of IBA* algorithm is significantly improved compared with existing algorithms in path length, turning times, number of units and coverage rate. The invention provides a theoretical basis for the research on the coverage path planning of the USMV, can promote the unmanned and intelligent process of marine measurement from the aspect of coverage path planning algorithm design, reduces the cost of marine information construction, and has wide application prospects and scientific value.

### BRIEF DESCRIPTION OF THE DRAWINGS

FIG. 1 is a flow block diagram illustrating a coverage-path planning method for a single unmanned surface mapping vessel in accordance with an embodiment of the present invention; and

FIG. 2 is a flow diagram illustrating the coverage-path planning method for the single unmanned surface mapping vessel in accordance with an embodiment of the present invention.

### DETAILED DESCRIPTION

In order to make the objectives, technical solutions and advantages of the invention more clear, the invention will be described in further detail below in conjunction with the accompanying drawings and embodiments. It should be understood that the specific embodiments described herein are intended only to explain the invention and are not intended to limit it. Further, the technical features related to the various embodiments of the present invention described below can be combined with each other as long as they do not conflict with each other.

The invention provides an optimized coverage-path planning method (IBA*) for a single unmanned surface mapping vessel, which improves the coverage rate and coverage effect of the unmanned surface mapping vessel in a complex working environment and improves the working efficiency of the unmanned surface mapping vessel. In order to make the above objectives, features and advantages of the invention more obvious and understandable, the invention will be further described in detail in combination with the drawings and specific embodiments.

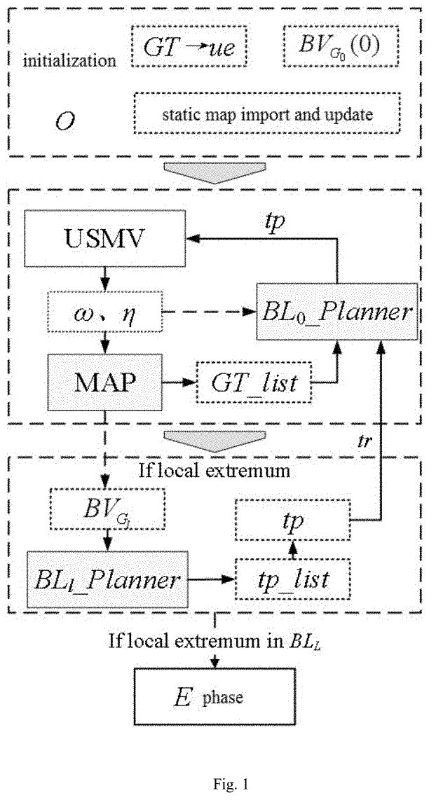

FIG. 1 is a flow block diagram illustrating the coverage-path planning method for the single unmanned surface mapping vessel in accordance with an embodiment of the present invention, and the method shown in FIG. 1 includes four phases: an O phase, a BL₀-level map phase, a BLₗ-level map phase, and an E phase.

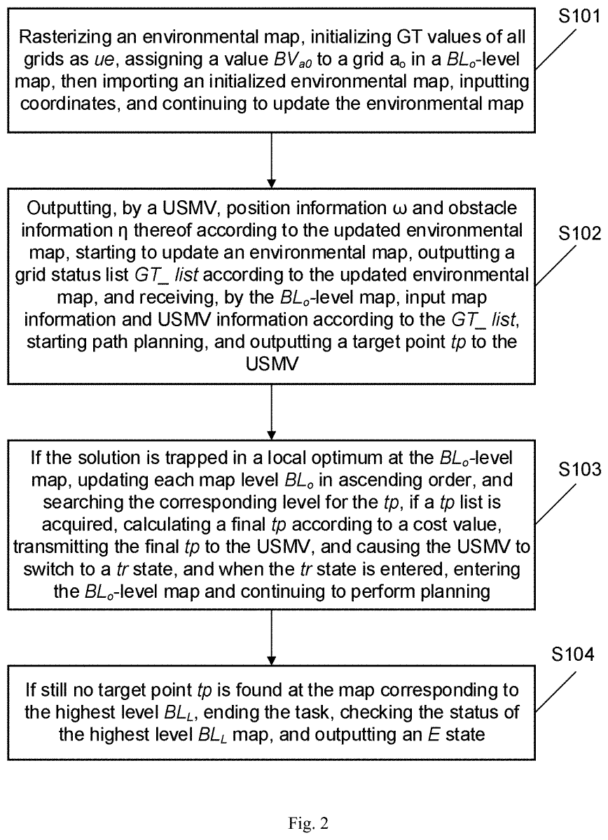

In particular, FIG. 2 is a flow diagram illustrating the coverage-path planning method for the single unmanned surface mapping vessel in accordance with an embodiment of the present invention, and the method includes the steps of:

S101: an environmental map is rasterized, GT values of all grids are initialized as ue, a value BVₐ₀ is assigned to a grid a₀ in a BL₀-level map, then an initialized environmental map is imported, coordinates are input, and the environmental map is continued to be updated;

The grid specific state is defined as GT, and the ue represents the free space where the bathymetry mission is not completed.

The environmental map is rasterized: the rasterization method divides the environmental map into several equally sized adjacent grids for easy update and maintenance. The environmental map is first quantized at a certain size, grid coordinates are established, then the coordinated grids are placed in one array, and attribute assignment is made to each grid for distinguishing different locations or grid cells.

S102: a USMV outputs position information ω and obstacle information η thereof according to the updated environmental map, an environmental map is started to update, a grid status list GT_list is output according to the updated environmental map, and the BL₀-level map receives input map information (such as the state and assigned value of a generated grid map) and USMV information according to the GT_list, path planning is started, and a target point tp is output to the USMV, wherein the tp represents an index value of the grid where a next target point of the USMV is located;

BL₀, . . . BL_{L} represent respective dynamic map levels BaseLayer and L is the highest level.

OC represents a USMV task instruction.

ac represents directing the USMV to perform collision avoidance.

The specific grid status list is defined as GT_list, and

GT_list={obs,exp,fz,ue}

S103: if the solution is trapped in a local optimum at the BL₀-level map, each map level BL₀ is updated in ascending order, and the corresponding level is searched for the tp, if a tp list is acquired, a final tp is calculated according to a cost value, the final tp is transmitted to the USMV, and the USMV is caused to switch to a tr state, and when the tr state is entered, entering the BL₀-level map and continuing to perform planning; wherein the tr state represents a non-normal task state after the USMV is in a Travel state and reaches local optimum.

S104: if still no target point tp is found at the map corresponding to the highest level BL_{L}, the task is ended, the status of the highest level BL_{L} map is checked, and an E state is output; wherein the S state represents a list of states, the O state represents a start state, the E state represents an end state, and the COM state represents a calculation state.

In some alternative embodiments, the step S101 may be implemented by:

The GT_list is updated first, since the USMV has not yet started to traverse and the number of exps is 0, the vast majority of grids are defined as a ue state, a preset assigned value BVₐ₀ of the grid a₀ in the BL₀-level map is calculated and updated level by level till the highest BL_{L}-level, eventually environmental map information is imported, obstacles, exclusion zones, and navigable waters are updated, respectively, at the same time, the USMV starts to record and transfer position information ω and obstacle information η thereof, thus starting circular traversal officially; wherein the vast majority of the embodiments of the present invention represent a preset number, which can be determined according to actual needs.

In some alternative embodiments, the step S102 may be implemented by:

a detection field of the USMV in the updated environmental map is recorded as D⁰(ω), ω∈D⁰(ω) wherein wherein the D⁰(ω) contains all the grid information perceptible to the USMV at the current position; for each grid a₀ in the D⁰(ω), if a connection line with the ω does not pass through a grid in a fz or obs state and a potential energy value of the grid a₀ is positive, a grid set satisfying the above requirements is defined as a priority field F⁰⊆D⁰(μ), wherein the D⁰(μ) represents the priority field determined from the D⁰(ω); for coverage of the BL₀-level map, since a priority path of the USMV is to complete the coverage task in the direction of a single scanning line, the grid on the same scanning line in the D⁰(ω) is preferentially selected as the target point, the grids in the D⁰(ω) in both north and south directions are defined as ω^{N} and ω^{S}, if BV_{ω}>0 and {ω^{N},ω^{S}}⊂F⁰, wherein, ω represents the grid sequence number of the position where the USMV is currently located, the BV is the potential value of the ω grid, in order to circumvent the case of massive backtracking, the grid adjacent to the obstacle is preferentially selected from the two grids, the grid is denoted as tp_{obs}, in the case where both the ω^{N} and ω^{s} meet the condition, both are introduced into a cost calculation formula to calculate the potential cost values J(tp) produced by both paths, and a relatively optimum path is selected from local and global points of view:

The purpose of calculating the potential cost value is to comprehensively consider the moving distance, turning angle and global trend, so that the tp of the USMV is in a reasonable range of the map. Calculating the situation can make the USMV give priority to cover areas with the high task completion degree and avoid redundant paths in large blank areas.

If there is an adjacent obstacle on only one side of ω^{N} and ω^{s}, then then a ω^{N} or ω^{s} orientation where the adjacent obstacle is located is given priority to start traversal, wherein in the case of BV_{ω}>0, the above judgment conditions are not met, then the situation should be: the ω grid where the USMV is located has not yet been explored, in the two upper and lower orientations, one side is the mission completion or obstacle area and the other side is the free space that has not yet been explored, at the moment, the ω is the tp point, and the USMV switches to a tc instruction which guides the USMV to start the actual bathymetry mission.

If BV_{ω}=0, F⁰≠Ø, the USMV has completed the task on the single scanning line, and starts to turn to the next phase of traversal, at the moment, the grid α₀ with the largest BV_{F}_{⁰}_{(ω)} as is taken the tp point, the next action is started.

If none of the above cases are met, it is determined that the USMV is in the locally optimum state at the moment, wherein the most likely case is driving into a concave obstacle field or being surrounded by an area with BV≥0, at the moment, the high-level map phase is started for path finding, and a tr instruction is output. The tr instruction represents a non-normal task state after the USMV is in a Travel state and reaches local optimum.

The priority field is determined by:

F⁰={α₀∈D⁰(ω):BV_{α}_{₀}>0}

The potential cost value is determined by:

J(tp)=k_{θ}·θ(ω,tp)+k_{d}·d(ω,tp)+k_{id}·Nₑₓₚ,

wherein,

d(ω,tp)=∥(ωₓ,ω_{y})−(tpₓ,tp_{y})∥₂

k_{θ} represents a turn cost coefficient and is considered as a unit turn angle cost; θ represents an absolute value of an angular change; k_{d} represents a distance cost coefficient, and is considered as a unit distance movement cost; d represents a Euclidean distance; kᵤₗ represents a global trend coefficient and is considered as as the cost of changing the situation; Nₑₓₚ represents the number of ue-state grids in the input direction, (ωₓ,ω_{y}) represents the horizontal and vertical coordinates of the ω point, and (tpₓ,tp_{y}) represents the horizontal and vertical coordinates of the tp point.

In some alternative embodiments, in the step S103, the BLₗ-level map phase refers to a phase where the level is higher than the BL₀-level map, i.e. 1≤l≤Land L represents the number of map phases. First, the detection field and priority field at the BLₗ-level map phase are defined: the USMV detection field at the ω position in the BLₗ-level map and having the detection range of RI, is defined as D^{l}(ω), wherein ω∈D^{l}(ω); the field in the detection domain D^{l}(ω) that is reachable through an adjacent path with ω and is positive in the BV_{α}_{ₗ} value is defined as the priority field F^{l}⊆D^{l}(ω): a BLₗ-level phase with l=1 is switched, a level-1 map grid αₗ with the largest BV_{F}_{^{l}}_{(ω)} is found in P, wherein, according to the map update manner, a high-level grid contains its corresponding low-level grid, at the moment, there may be no less than 2 tp points in the high-level grid tp list; its potential cost value J(tp) is continued to be calculated in the COM state, the optimum tp point is selected, the USMV starts the bathymetry task.

Because of the strategy of IBA* algorithm for priority obstacle avoidance, the local optimum case occurs in the vast majority of cases at the end of the obstacle or at the end of the scanning line, an adjacent path in the tr state is calculated with a greedy algorithm, i.e. the obstacle contour is continued to be tracked until the USMV moves directly to the target point, the state of entering the locally optimum area is broken away and the target point is reached, in the scanning task, for a scenario in which a dynamic obstacle exists, a collision avoidance action is performed by the USMV, and the USMV switches to the tr state, the BL₀-level map is continued to be entered after past and clear, the coverage operation is resumed, if it is still impossible to break away from the local optimum when l=1, the map is updated level by level until the tp point is derived and if there is no solution when l=L, then it is preliminarily determined that the traversal is completed.

At the BL-level map phase, the priority domain is specifically expressed as:

F^{l}={αₗ∈D^{l}(ω):BVαₗ>0}

In some alternative embodiments, in the step S104, based on the known partial environmental information, reviewing missing areas, generating coverage rate information, and considering whether to switch the tr state to perform the return or continue the scanning task in a specific area according to the actual state requirements of the USMV.

The application also provides a computer-readable storage medium, such as a flash memory, a hard disk, a multimedia card, a card-type memory (e.g., SD or DX memory, etc.), a random access memory (RAM), a static random access memory (SRAM), a read-only memory (ROM), an electrically erasable programmable read-only memory (EEPROM), a programmable read-only memory (PROM), a magnetic memory, a disk, an optical disk, a server, an App market, etc., a computer program is stored thereon which, when executed by a processor, implements the coverage-path planning method for the single unmanned surface mapping vessel in a method embodiment.

It should be noted that the various steps/components described in the present application may be split into more steps/components or two or more steps/components or partial operations of the steps/components may be combined into new steps/components to achieve the objectives of the present invention, depending on the requirements of the implementation.

It will be readily understood by those skilled in the art that the above description is only preferred embodiments of the present invention and is not intended to limit the present invention. Any modification, equivalent replacement, improvement, etc. made within the spirit and principles of the present invention should be included in the scope of protection of the present invention.

What is claimed is:

1. A coverage-path planning method for a single unmanned surface mapping vessel, comprising:
(1) rasterizing an environmental map, initializing GT values of all grids as ue, assigning a value BVₐ₀ to a grid a₀ in a BL₀-level map, then importing the initialized environmental map, inputting coordinates, and continuing to update the environmental map, wherein the ue represents a free space where the bathymetry mission is not completed;
(2) outputting, by a Unmanned Surface Mapping Vessel (USMV), position information ω and obstacle information η thereof according to the updated environmental map, starting to update the environmental map, outputting a grid status list GT_list according to the updated environmental map, and receiving, by the BL₀-level map, input map information and USMV information according to the GT_list, starting path planning, and outputting a target point tp to the USMV, wherein the tp represents an index value of the grid where a next target point of the USMV is located;
(3) if the solution is trapped in a local optimum at the BL₀-level map, updating each map level BL₀ in ascending order, and searching the corresponding level for the tp, if a tp list is acquired, calculating a final tp according to a cost value, transmitting the final tp to the USMV, and causing the USMV to switch to a tr state, and when the tr state is entered, entering the BL₀-level map and continuing to perform planning, wherein the tr state represents a non-normal task state after the USMV is in a Travel state and reaches local optimum; and
(4) if still no target point tp is found at the map corresponding to a highest level BL_{L}, ending the task, checking a status of the highest level BL_{L} map, and outputting an E state, wherein the E state represents an end state.

2. The method according to claim 1, wherein the step (1) comprises:
updating the GT_list first, since the USMV has not yet started to traverse and a number of exp is 0, defining a vast majority of grids as a ue state, calculating a preset assigned value BVₐ₀ of the grid a₀ in the BL₀-level map and updating level by level till the highest BL_{L}-level, eventually importing environmental map information, updating obstacles, exclusion zones, and navigable waters, respectively, starting, by the USMV, recording and transferring position information ω and obstacle information η thereof, thus starting circular traversal officially, wherein the exp represents the free space where the bathymetry mission has been completed.

3. The method according to claim 1, wherein the step (2) comprises:
recording a detection field of the USMV in the updated environmental map as D⁰(ω), ω∈D⁰(ω) wherein wherein the D⁰(ω) contains all the grid information perceptible to the USMV at a current position;
for each grid a₀ in the D⁰(ω), if a connection line with the ω does not pass through a grid in a fz or obs state and a potential energy value of the grid a₀ is positive, defining a grid set satisfying the above requirements as a priority field F⁰⊆D⁰(μ), wherein the D⁰(ω) represents the priority field determined from the D⁰(ω);
for coverage of the BL₀-level map, since a priority path of the USMV is to complete the coverage task in the direction of a single scanning line, preferentially selecting the grid on the same scanning line in the D⁰(ω) as the target point, defining the grids in the D⁰(ω) in both north and south directions as ω^{N} and ω^{s}, if BV_{ω}>0 and {ω^{N},ω^{S}}⊂F⁰, wherein, the BV is the grid potential value, in order to circumvent the case of massive backtracking, preferentially selecting the grid adjacent to the obstacle from the two grids, denoting the grid as tp_{obs}, in the case where both the ω^{N} and ω^{s} meet the condition, introducing both into a cost calculation formula to calculate the potential cost values J(tp) produced by both paths, and selecting a relatively optimum path from local and global points of view;
if there is an adjacent obstacle on only one side of ω^{N} and ω^{s}, then then giving priority to a ω^{N} or ω^{s} orientation where the adjacent obstacle is located to start traversal, wherein in the case of BV_{ω}>0, the ω grid where the USMV is located has not yet been explored, in the two upper and lower orientations, one side is the mission completion or obstacle area and the other side is the free space that has not yet been explored, at the moment, the ω is the tp point, and the USMV switches to a tc instruction which guides the USMV to start the actual bathymetry mission;
if BV_{ω}=0, F⁰≠Ø, determining that the USMV has completed the task on the single scanning line, starting to turn to the next phase of traversal, at the moment, taking the grid α₀ with the largest BV_{F}_{⁰}_{(ω)} as the tp point, starting the next action; and
if none of the above cases are met, determining that the USMV is in the locally optimum state at the moment, wherein the most likely case is driving into a concave obstacle field or being surrounded by an area with BV≤0 at the moment, starting the high-level map phase for path finding, and outputting a tr instruction.

4. The method according to claim 3, wherein the priority field is determined by:
F⁰={α₀∈D⁰(ω)):BV_{α}_{₀}>0}.

5. The method according to claim 4, wherein
the potential cost value is determined by:
J(tp)=k_{θ}·θ(ω,tp)+k_{d}·d(ω,tp)+kᵤₗ·Nₑₓₚ,
wherein,
d(ω,tp)=∥(wₓ,w_{y})−(tpₓ,tp_{y}∥₂,
k_{θ} represents a turn cost coefficient and is considered as a unit turn angle cost; θ represents an absolute value of an angular change; k_{d} represents a distance cost coefficient, and is considered as a unit distance movement cost; d represents a Euclidean distance; kᵤₗ represents a global trend coefficient and is considered as as the cost of changing the situation; Nₑₓₚ represents the number of ue-state grids in the input direction, (ωₓ,ω_{y}) represents the horizontal and vertical coordinates of the ω point, and (tpₓ,tp_{y}) represents the horizontal and vertical coordinates of the tp point.

6. The method according to claim 5, wherein the step (3) comprises:
switching to a BL₁-level phase with l=1, finding a level-1 map grid α₁ with the largest BV_{F}_{^{l}}_{(ω)} in F^{l}, wherein, according to the map update manner, a high-level grid contains its corresponding low-level grid, at the moment, there may be no less than 2 tp points in the high-level grid tp list; continuing to calculate its potential cost value J(tp) in the COM state, selecting the optimum tp point, making the USMV start the bathymetry task, and defining the detection field and priority field at the BLₗ-level map phase: defining the USMV detection field at the ω position in the BLₗ-level map and having the detection range of R_{L} as D^{l}(ω), wherein ω∈D^{l}(w); defining the field in the detection domain D^{l}(ω) that is reachable through an adjacent path with ω and is positive in the BV_{α}_{ₗ} value as the priority field F^{l}⊆D^{l}(ω), wherein the BLₗ-level map phase refers to a phase where the level is higher than the BL₀-level map, i.e. 1≤l≤L, and L represents the number of map phases; and
since the local optimum case occurs in the vast majority of cases at the end of the obstacle or at the end of the scanning line, calculating an adjacent path in the tr state with a greedy algorithm, i.e. continuing to track the obstacle contour until moving directly to the target point, breaking away from the state of entering the locally optimum area and reaching the target point, in the scanning task, for a scenario in which a dynamic obstacle exists, performing a collision avoidance action by the USMV, and switching to the tr state, continuing to enter the BL₀-level map after past and clear, resuming the coverage operation, if it is still impossible to break away from the local optimum when l=1, updating the map level by level until the tp point is derived and if there is no solution when l=L, then preliminarily determining that the traversal is completed.

7. The method according to claim 6, wherein, at the BL-level map phase, the priority domain is specifically expressed as:
F^{l}={αₗ∈D^{l}(ω):BV_{α}_{ₗ}>0}

8. The method according to claim 1, wherein the step (4) comprises:
based on the known partial environmental information, reviewing missing areas, generating coverage rate information, and considering whether to switch the tr state to perform the return or continue the scanning task in a specific area according to the actual state requirements of the USMV.

9. A computer-readable storage medium, having stored thereon a computer program, wherein the computer program, when executed by a processor, implements the steps of the method according to claim 1.
